(19) United States
(12) Patent Application Publication
(10) Pub. No.: US 2018/0239204 A1
(43) Pub. Date: Aug. 23, 2018

(54) FRINGE FIELD SWITCHING (FFS) MODE ARRAY SUBSTRATE AND MANUFACTURING METHOD THEREFOR

(71) Applicant: SHENZHEN CHINA STAR OPTOELECTRONICS TECHNOLOGY CO. LTD., Guangdong (CN)

(72) Inventor: QIMING GAN, GUANGDONG (CN)

(21) Appl. No.: 15/513,916

(22) PCT Filed: Feb. 13, 2017
(86) PCT No.: PCT/CN2017/073337

§ 371 Date: Mar. 23, 2017

(30) Foreign Application Priority Data
Jan. 3, 2017 (CN) 201710002315.3

(51) Int. Cl. G02F 1/1343; G02F 1/1362; G02F 1/1333

(52) U.S. Cl. CPC G02F 1/134363; G02F 1/136286; G02F 2201/121; G02F 2001/134372; G02F 1/133345

(57) ABSTRACT

The present disclosure provides a Fringe Field Switching (FFS) mode array substrate and manufacturing method therefor. The array substrate comprises a plurality of scanning lines, a plurality of data lines, and a common electrode. The array substrate further comprises a plurality of conductive strips disposed between the scanning lines and the common electrode, and electrically connected to the common electrode, for conducting electric signal of the common electrode. The array substrate can keep the electric signal on the common electrode the same, and improve the display effect of the liquid crystal panel using the array substrate.

### BACKGROUND OF THE INVENTION

### Field of Invention

The present disclosure relates to the field of display technology, particularly to a Fringe Field Switching (FFS) mode array substrate and a manufacturing method therefor.

### Description of Prior Art

Fringe Field Switching (FFS) is a fringe field liquid crystal display (LCD) mode which is called FFS mode. FFS mode LCD panels with the advantages of high light transmittance, wide viewing angles, etc., are widely used in wide viewing angle LCD technology. In an FFS mode LCD, an electric field is formed by the common electrode and the pixel electrode to realize the control of the liquid crystal so as to achieve the purpose of image display. The common electrode is a single electrode layer, the potential of the pixel electrode is controlled independently through data lines, and the potential of the common electrode is controlled independently through an external circuit.

However, for a large-sized FFS mode LCD panel, since the resistance of the common electrode is high, that is, the resistance of indium tin is high, delay of the common electrode signal easily occurs, so that the common voltages in different regions of the LCD panel are different, and the quality of the image display is affected.

Therefore, it is necessary to provide an FFS mode array substrate and a manufacturing method therefor to solve the issues of the conventional art.

### SUMMARY OF THE INVENTION

The present disclosure provides an FFS mode array substrate and a manufacturing method therefor to solve the technical issue arising from the difference between signals of the common potential of the common electrode of the FFS mode array substrate of the conventional art.

The present disclosure provides a Fringe Field Switching (FFS) mode array substrate which comprises a plurality of scanning lines, a plurality of data lines, and a common electrode, and further comprises a plurality of conductive strips disposed between the scanning lines and the common electrode, the conductive strips and the data lines being disposed in different layers, and the conductive strips being electrically connected to the common electrode, for transmitting electric signals of the common electrode.

In the FFS mode array substrate of the present disclosure, the FFS mode array substrate further comprises a dielectric layer, which is disposed between the data lines and the conductive strips, for insulating the data lines and the conductive strips.

In the FFS mode array substrate of the present disclosure, the FFS mode array substrate further comprises a planarization layer. The planarization layer is disposed on the conductive strips. The common electrode is disposed on the planarization layer. The planarization layer comprises through holes, the common electrode is electrically connected with the conductive strips via the through holes.

In the FFS mode array substrate of the present disclosure, the conductive strips and the scanning lines are disposed correspondingly.

In the FFS mode array substrate of the present disclosure, a length of the conductive strip and a length of the scanning line are the same.

In the FFS mode array substrate of the present disclosure, a quantity of the conductive strips and a quantity of the scanning lines are the same.

In the FFS mode array substrate of the present disclosure, materials of the conductive strips comprise aluminum, copper, or molybdenum.

The present disclosure further provides an FFS mode array substrate, which comprises a plurality of scanning lines, a plurality of data lines, and a common electrode, and further comprises a plurality of conductive strips disposed between the scanning lines and the common electrode, the conductive strips being electrically connected to the common electrode, for transmitting electric signals of the common electrode.

In the FFS mode array substrate of the present disclosure, the conductive strips and the data lines are insulated and disposed apart from each other in the same layer.

In the FFS mode array substrate of the present disclosure, the FFS mode array substrate further comprises a dielectric layer and a planarization layer, which are disposed on the data lines and the conductive strips. The common electrode is disposed on the planarization layer. Through holes are disposed in the dielectric layer and the planarization layer. The common electrode is electrically connected with the conductive strips via the through holes.

In the FFS mode array substrate of the present disclosure, the through holes comprise two through holes corresponding with two end portions of the conductive strips. The common electrode is electrically connected with the conductive strips via the two through holes.

In the FFS mode array substrate of the present disclosure, the conductive strips and the scanning lines are disposed correspondingly.

In the FFS mode array substrate of the present disclosure, materials of the conductive strips comprise aluminum, copper, or molybdenum.

In the FFS mode array substrate of the present disclosure, shapes of the conductive strips comprise rectangular or the middle is rectangular and two end portions are semi-circular.

In the FFS mode array substrate of the present disclosure, materials of the conductive strips are the same as the materials of the data lines, and the conductive strips are formed at the same time as the data lines are formed.

The present disclosure further provides a manufacturing method of an FFS mode array substrate, which comprises:

A first metal layer is manufactured on a substrate, to form a plurality of scanning lines;

An insulating layer is manufactured on the first metal layer; and

A second metal layer, a third metal layer, and a common electrode layer are manufactured on the insulating layer, to individually form a plurality of data lines, a plurality of conductive strips, and a common electrode;

The conductive strips are disposed between the scanning lines and the common electrode. The conductive strips are electrically connected to the common electrode.

In the manufacturing method of the present disclosure, the second metal layer and the third metal layer are in the same layer. The step of a second metal layer, a third metal layer, and a common electrode layer being manufactured on the insulating layer, to individually form a plurality of data lines, a plurality of conductive strips, and a common electrode comprises:

The second metal layer and the third metal layer are manufactured on the insulating layer, to form the plurality of data lines and the plurality of conductive strips. The data lines and the conductive strips are insulated and disposed apart from each other;

A first dielectric layer and a first planarization layer are manufactured in order on the second metal layer and the third metal layer; and

The common electrode layer is manufactured on the first planarization layer to form the common electrode.

In the manufacturing method of the present disclosure, the step of a first dielectric layer and a first planarization layer are manufactured in order on the second metal layer and the third metal layer comprises:

The first dielectric layer is manufactured on the second metal layer and the third metal layer, and a first sub through hole is formed on the first dielectric layer by a first photomask; and

The first planarization layer is manufactured on the first dielectric layer and a second sub through hole is formed on the first dielectric layer by a second photomask. A first through hole is formed by the first sub through hole and the second sub through hole together. The common electrode is electrically connected with the conductive strips via the first through hole.

In the manufacturing method of the present disclosure, the second metal layer and the third metal layer are different layers. The step of a second metal layer, a third metal layer, and a common electrode layer being manufactured on the insulating layer, to individually form a plurality of data lines, a plurality of conductive strips, and a common electrode comprises:

The second metal layer is manufactured on the insulating layer, to form the plurality of data lines;

A second dielectric layer is manufactured on the second metal layer;

The third metal layer is manufactured on the second dielectric layer, to form the plurality of conductive strips;

A second planarization layer is manufactured on the third metal layer, and a second through hole is formed in the second planarization layer by a third photomask; and

The common electrode layer is manufactured on the second planarization layer to form the common electrode. The common electrode is electrically connected with the conductive strips via the second through hole.

In the manufacturing method of the present disclosure, the step of the third metal layer being manufactured on the second dielectric layer, to form the plurality of conductive strips comprises:

The third metal layer is manufactured on a position where the conductive strips and the scanning lines are disposed correspondingly, to form the plurality of conductive strips.

The present disclosure provides an FFS mode array substrate and a manufacturing method therefor. The FFS mode array substrate disposes the conductive strips between the scanning lines and the common electrode, the conductive strips are electrically connected to the common electrode, then, the electric signal of the common electrode of the FFS mode array substrate keeps consistent by using the conductive strips to transmit the electric signal of the common electrode, then, the display effect of the LCD panel thereof is raised correspondingly.

### BRIEF DESCRIPTION OF THE DRAWINGS

FIG. 1 is a flow diagram of a manufacturing method of Fringe Field Switching (FFS) mode array substrate according to one embodiment of the present disclosure.

FIG. 2 is a structural drawing of the step S11 of the manufacturing method of the array substrate of FIG. 1.

FIG. 3 is a structural drawing of the step S12 of the manufacturing method of the array substrate of FIG. 1.

FIG. 4 is a specific flow diagram of the step S13 of the manufacturing method of the array substrate of FIG. 1.

FIGS. 5-8 are flow diagrams of the manufacturing method of the array substrate of FIG. 4.

FIG. 9 is a top-view structural drawing of the array substrate of FIG. 7.

FIG. 10 is another specific flow diagram of the step S13 of the manufacturing method of the array substrate of FIG. 1.

FIG. 11 is a structural drawing of the manufacturing method of the array substrate of FIG. 10.

### DETAILED DESCRIPTION OF THE PREFERRED EMBODIMENTS

The following description of each embodiment, with reference to the accompanying drawings, is used to exemplify specific embodiments which may be carried out in the present invention. Directional terms mentioned in the present invention, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present invention.

In FIGS. 2, 3, 5-9, and 11, units with similar structures are marked with the same labels.

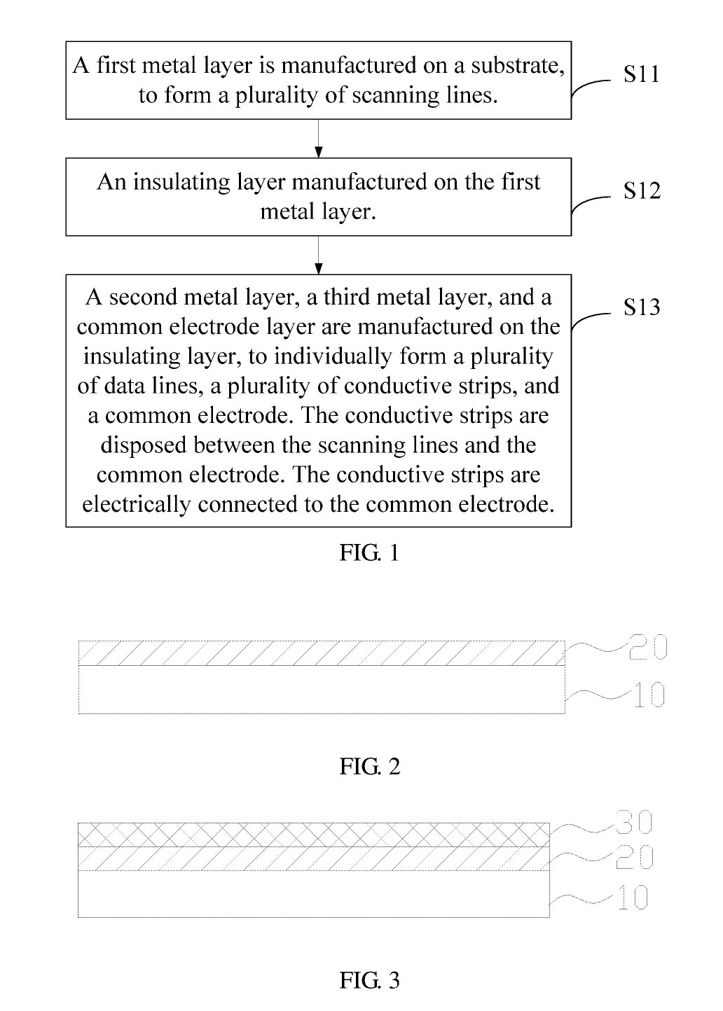

The present embodiment provides a manufacturing method of Fringe Field Switching (FFS) mode array substrate, please refer to FIGS. 1-11. The method comprises the following steps:

Step S11: A first metal layer is manufactured on a substrate, to form a plurality of scanning lines.

The substrate 10 can be glass substrate for providing a support function and carrying each element of the array substrate. The first metal layer is manufactured on the substrate 10 by applying a process such as physical deposition, to form the plurality of scanning lines 20, as shown in FIG. 2.

In FIG. 2, a cross section of only one data line along a direction perpendicular to the substrate 10 is shown. It is appreciated that the plurality of scanning lines 20 are disposed apart.

The first metal layer, in other words, the plurality of scanning lines can be molybdenum (MO), aluminum (Al) or copper (Cu), but is not limited herein.

Step S12: An insulating layer manufactured on the first metal layer.

After the formation of the first metal layer 20, an insulating layer 30 is formed on the first metal layer by plasma enhanced chemical vapor deposition in order to prevent electrical contact between the first metal layer and the second metal layer, as shown in FIG. 3.

Step S13: A second metal layer, a third metal layer, and a common electrode layer are manufactured on the insulating layer, to individually form a plurality of data lines, a plurality of conductive strips, and a common electrode. The conductive strips are disposed between the scanning lines and the common electrode. The conductive strips are electrically connected to the common electrode.

In this embodiment, the second metal layer and the third metal layer are in the same layer, in which case the second metal layer and the third metal layer are simultaneously formed, that is, the plurality of data lines and the plurality of conductive strips are simultaneously formed, the time to fabricate the array substrate does not increase, meanwhile, the complexity of fabricating the array substrate does not increase.

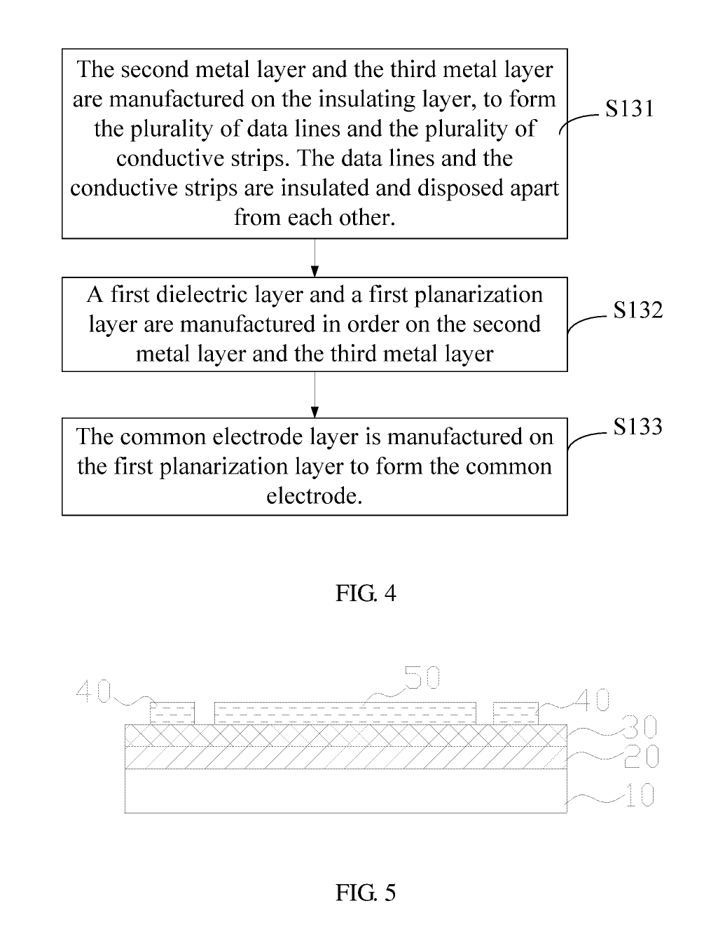

Please refer to FIG. 4, which is a specific flow diagram of the step S13 of the manufacturing method of the array substrate of FIG. 1. The step S13 specifically comprises the following steps:

Step S131: The second metal layer and the third metal layer are manufactured on the insulating layer, to form the plurality of data lines and the plurality of conductive strips. The data lines and the conductive strips are insulated and disposed apart from each other.

After the formation of the insulating layer 30, the second metal layer and the third metal layer are simultaneously formed on the insulating layer 30 by a physical vapor deposition process or the like to form the plurality of data lines 40 and conductive strip 50, as shown in FIG. 5.

It is appreciated that the plurality of data lines 40 are disposed apart. In general, the plurality of data lines 40 are arranged vertically, i.e., perpendicular to the direction of the sheet surface, and the plurality of scanning lines 20 are horizontally disposed, i.e., parallel to the direction of the sheet surface. So that the plurality of data lines 40 and the plurality of scanning lines 20 are insulated interleaved from each other to form a plurality of sub-pixel units. Each data line 40 is used to connect sub-pixel units in the same column, and each scan line 20 is used to connect sub-pixel units on the same row.

In FIG. 5, the sub-pixel unit is in a region between two data lines 40. In order to avoid affecting the aperture ratio of the sub-pixel unit, the third metal layer is disposed at a position corresponding to the scanning line 20, i.e., the plurality of conductive strips 50 are disposed directly above the scanning line 20.

In the present embodiment, the conductive strips 50 are made of the same material as the plurality of data lines 40, that is, metal such as MO, Al, or Cu. Of course, the conductive strip 50 may be different from the material of the plurality of data lines 40, for example, MO metal for the data line 40 and Al metal for the conductive strip 50.

The width of the conductive strip 50 may be the same as the width of the scanning line 20 such that the conductive strip 50 covers just above the scanning line 20.

In order to avoid causing signal crosstalk, the conductive strip 50 is insulated from the data line 40. Specifically, both end portions of the conductive strip 50 are disposed apart from the data lines 40 on both sides.

Step S132: A first dielectric layer and a first planarization layer are manufactured in order on the second metal layer and the third metal layer.

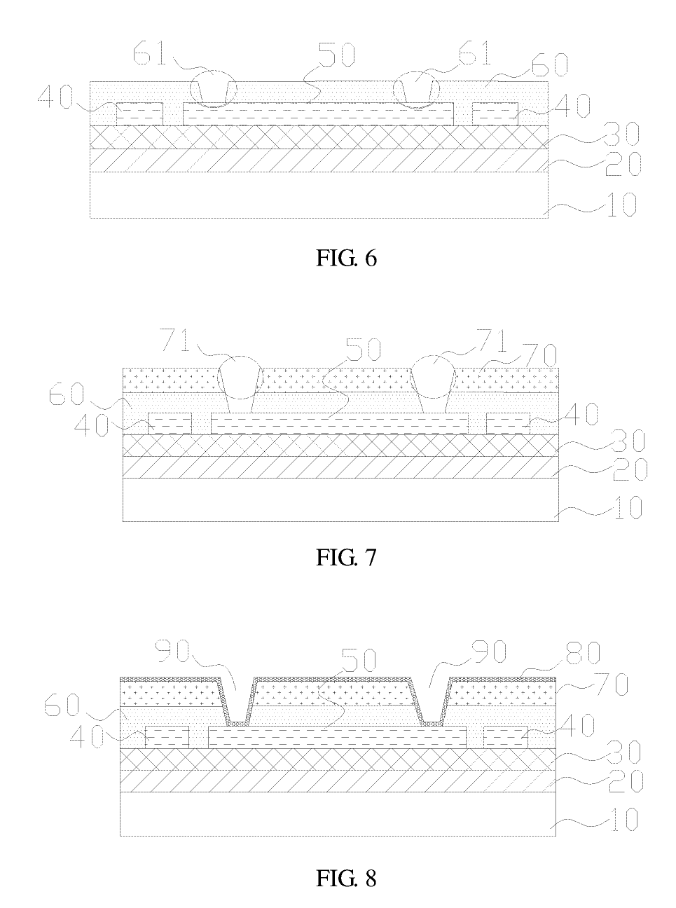

After the formation of the data lines 40 and the conductive strip 50, in order to insulate the data lines 40 from the other conductive structures, the first dielectric layer 60 is typically formed on the second metal layer and the third metal layer. A first sub through hole 61 is formed in the first dielectric layer 60 by a first photomask, as shown in FIG. 6.

The first sub through hole 61 is a vertically penetrating hole, and the conductive strip 50 is visible via the first sub through hole 61 from the direction perpendicular to the substrate 10.

In order to planarize the surface of the array substrate, a first planarization layer 70 is formed on the first dielectric layer 60, as shown in FIG. 7, after the formation of the above-described structure.

The second sub through hole 71 is formed in the first planarization layer 70 by the second photomask when the first planarization layer 70 is being manufactured.

In which the second sub through hole 71 corresponds to the first sub through hole 61 and the first through hole 90 is constituted by the second sub through hole 71 and the first sub through hole 61, as shown in FIG. 8.

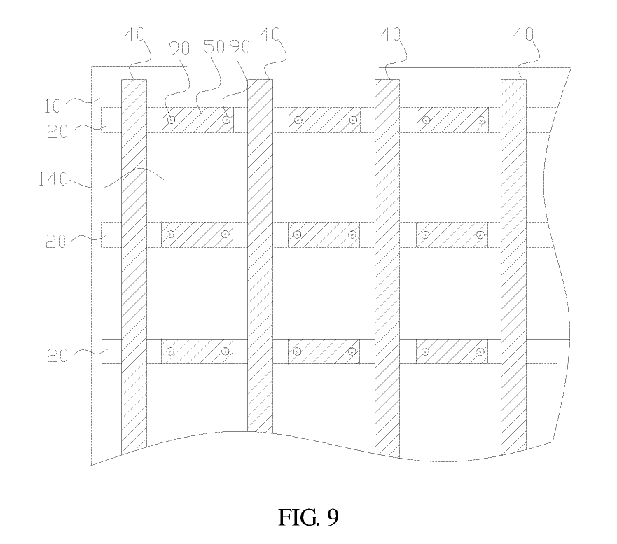

Please Refer to FIG. 9, which is a top-view structural drawing of the array substrate of FIG. 7. The plurality of data lines 40 and the plurality of scanning lines 20 are interleaved to form a plurality of sub-pixel units 140. A thin film transistor, a pixel electrode, and other devices included in the sub-pixel unit 140 are not shown in FIG. 9.

In order to clearly show the positional relationship between the scanning line 20, the data line 40, the conductive strip 50, and the first through hole 90, the array substrate shown in FIG. 9 is a top-view drawing of removing the insulating layer 30, the first dielectric layer 60, and the first planarization layer 70, but retains the first through hole 90.

Although the insulating layer 30, the first dielectric layer 60, and the first planarization layer 70 are omitted from FIG. 9, a person having ordinary skill in the art can readily obtain a top-view drawing of the array substrate including the insulating layer 30, the first dielectric layer 60, and the first planarization layer 70, according to the description of the manufacturing method as mentioned above.

Step S133: The common electrode layer is manufactured on the first planarization layer to form the common electrode.

After the formation of the first flattened layer 70, the common electrode layer is manufactured on the first planarization layer 70 by a vapor deposition process or the like to form the common electrode 80, as shown in FIG. 8.

In the present embodiment, the common electrode 80 is a transparent electrode, for example, an indium tin oxide (ITO) electrode is used.

When manufacturing the common electrode 80, the common electrode 80 needs to cover the sidewalls of the first through hole 90 and the conductive strip 50 that is exposed via the first through hole 90 so that the common electrode 80 can be electrically connected to the conductive strip 50 via the first through hole 90.

When the control circuit of the large-screen liquid crystal panel inputs an electric signal to the common electrode 80, the common electrode 80 can transmit the electric signal by means of the conductive strip 50. Since the conductive strip 50 is made of a metal material, its resistivity is much smaller than that of ITO, the difference in the electric signals in each region of the common electrode 80 is greatly reduced with good uniformity.

In each sub-pixel unit of the present embodiment, the common electrode 80 is electrically contacted to the conductive strip 50 via the two first through holes 90, and it is understood that in other embodiments the quantity of the first through holes 90 is not limited in two, there may be more, it is not specifically limited herein.

When the quantity of the first through hole is greater than two, the plurality of first through holes may be arranged in the same row or in a plurality of rows. For example, when the quantity of the first through holes 90 is four, the four first through holes 90 may be arranged in two rows and two columns.

It is to be noted that the common electrode 80 is electrically connected to the conductive strip 50, but is not limited to a “through hole connection”, and it is not necessary for the dielectric layer 60 and the planarization layer 70 to make sub through holes by the photomask when the “through hole connection” is not used.

In the present embodiment, the two first through holes 90 correspond to the two end portions of the conductive strip 50, respectively. In other embodiments, the first through holes 90 may also correspond to other portions of the conductive strip 50, no specific restrictions are made herein.

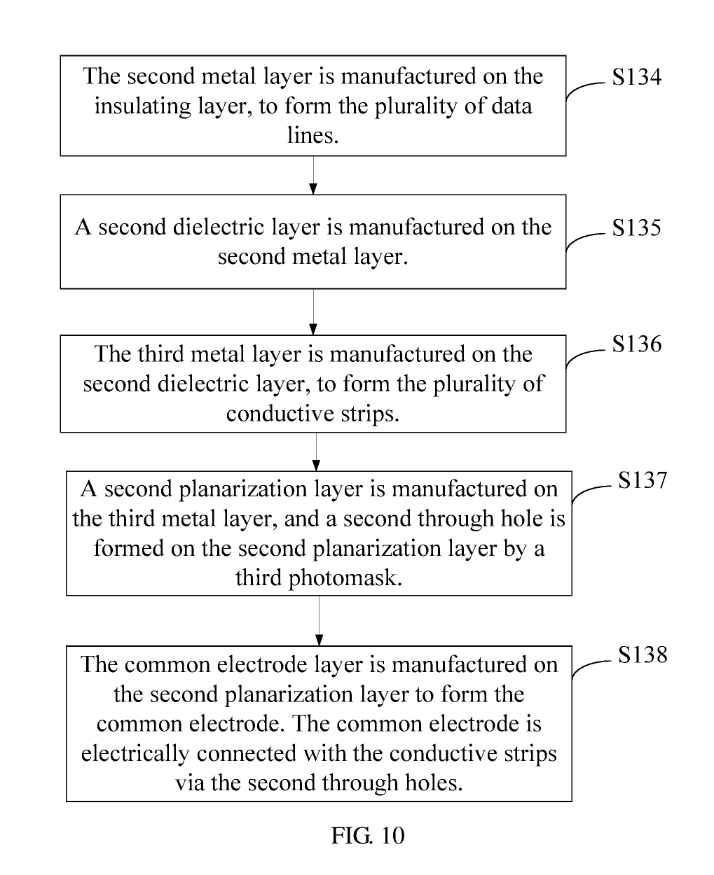

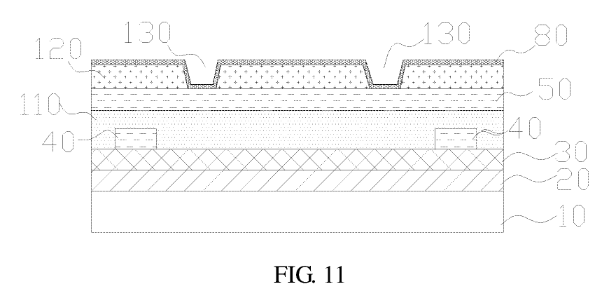

In one embodiment, the conductive strips 50 and the data lines 40 may also be in different layers, i.e. the second metal layer and the third metal layer are not the same layer. A specific flow diagram of step S13 is as shown in FIG. 10.

Step S13 includes the following steps:

S134: The second metal layer is manufactured on the insulating layer, to form the plurality of data lines.

As shown in FIG. 11, the second metal layer is manufactured on the insulating layer 30 by a physical vapor deposition process or the like, to form the plurality of data lines 40.

S135: A second dielectric layer is manufactured on the second metal layer.

A second dielectric layer 110 is manufactured on the second metal layer to insulate the data line 40 from other conductive structures.

S136: The third metal layer is manufactured on the second dielectric layer, to form the plurality of conductive strips.

The plurality of conductive strips 50 are formed on the second dielectric layer 110 by a physical vapor deposition process or the like. The conductive strips 50 correspond with the position of the scanning lines 20. The length of the conductive strip 50 may be less than or equal to the distance between the data lines 40 on the left and right sides of the sub-pixel unit.

Since the conductive strip 50 is insulated from the data line 40 by disposing on different layers, the length of the conductive strip 50 may be the same as the length of the entirety of the scanning lines 20, i.e., a plurality of sub-pixel units in the same row share the same conductive strip 50. For example, if there are M rows of scanning lines 20 in the array substrate, the M rows of conductive strips 50 correspond to the M rows of scanning lines, as shown in FIG. 11.

S137: A second planarization layer is manufactured on the third metal layer, and a second through hole is formed in the second planarization layer by a third photomask.

After the formation of the conductive strip 50, the second planarization layer 120 is manufactured on the third metal layer while the second through hole 130 is formed in the second planarization layer 120 by the third photomask.

In FIG. 11, the quantity of second through holes 130 is two, i.e., each sub-pixel unit corresponds to two second through holes 130. It is understood that when the same row of sub-pixel units share the same conductive strip 50, the quantity of second through holes 130 corresponding to each sub-pixel unit may be one, or a second through hole 130 is disposed between every two sub-pixel units, for electrically connecting the common electrode 80 and the conductive strip 50.

Of course, the quantity and arrangement of the second through holes 130 are not limited to the above, and may be set in accordance with parameters such as the size of the actual array substrate, and are not particularly limited thereto.

S138: The common electrode layer is manufactured on the second planarization layer to form the common electrode. The common electrode is electrically connected with the conductive strips via the second through holes.

After the formation of the second planarization layer 120, the common electrode layer is manufactured by a process such as physical vapor deposition to form the common electrode 80, which is electrically connected to the conductive strip via the second through hole 130.

The method for manufacturing an FFS mode array substrate according to the present embodiment provides a method of manufacturing a conductive strip on an array substrate such that the common electrode can transfer an electric signal by means of the conductive strip, to reduce the voltage difference among each region of the common electrode and to maintain the voltage uniformity of each region of the common electrode, so that the liquid crystal panel using the FFS mode array substrate has a better display effect.

The present embodiment provides an FFS mode array substrate, which is manufactured by a method of manufacturing an array substrate provided by an embodiment of the present invention.

FIG. 8, the array substrate includes a substrate 10, a plurality of scanning lines 20, a plurality of data lines 40, a common electrode 80, and a plurality of conductive strips 50.

In the array substrate, the plurality of scanning lines 20 are disposed apart on the substrate 10. The plurality of data lines 40 and the plurality of scanning lines 20 are interleaved, in order to prevent electrical contact between the scanning lines 20 and the data lines 40. In this embodiment, the array substrate further comprises an insulating layer 30 covering on the scanning line 20.

The plurality of data lines 40 are provided on the insulating layer 30 apart each other. It is understood that in the array substrate shown in FIG. 8, the plurality of data lines 40 are arranged vertically, i.e., perpendicular to the direction of the sheet surface, and the plurality of scanning lines 20 are horizontally arranged, i.e., parallel to the direction of the sheet surface. So that the plurality of data lines 40 and the plurality of scanning lines 20 are insulated interleaved from each other to form the plurality of sub-pixel units. Each data line 40 is used to connect sub-pixel units in the same column, and each scanning line 20 is used to connect sub-pixel units on the same row.

In the present embodiment, the material of the plurality of scanning lines 20 and the plurality of data lines 40 may be a metal such as MO, Al, or Cu, and the materials of the plurality of scanning lines 20 and the plurality of data lines 40 may be the same or different, no particular limitation is made herein.

The plurality of conductive strips 50 are provided directly above the scanning lines 20 corresponding to the sub-pixel units in order to avoid affecting the aperture ratio of the sub-pixel units. The width of the conductive strip 50 may be the same as the width of the scanning line 20, or may be slightly smaller or slightly larger than the width of the scanning line 20.

In the present embodiment, the shape of the conductive strip 50 is a regular rectangle, and it is understood that the conductive strip 50 may have other shapes such that the middle of the conductive strip 50 being rectangular and the two end portions of the rectangle being semi-circular and the like, and no specific limitation is made herein.

In order not to increase the time to manufacture the entire array substrate, the conductive strips 50 may be manufactured with the plurality of data lines 40 simultaneously, in which the conductive strips 50 and the plurality of data lines 40 are in the same layer. And the conductive strips 50 are insulated from the data lines at both sides of the conductive strips 50.

The conductive strip 50 may be the same as the material of the data line 40, that is, a metal such as MO, Al, or Cu. The material of the conductive strip 50 may be different from the material of the data line 40, for example, the conductive strip 50 is an MO metal and the data line 40 is an Al metal.

In the present embodiment, the array substrate further comprises a first dielectric layer 60 and a first planarization layer 70, and the first dielectric layer 60 and the first planarization layer 70 are disposed in order on the conductive strip 50 and the plurality of data lines 40. A common electrode 80 is provided on the first planarization layer 70, at which time the conductive strip 50 will be disposed between the scanning line 20 and the common electrode 80.

In the present embodiment, the common electrode 80 is a transparent electrode such as ITO.

In order to electrically connect the conductive strip 50 to the common electrode 80, the first dielectric layer 60 and the first planarization layer 70 in the present embodiment are provided with the through holes 90, for electrically connecting between the conductive strip and the common electrode 80.

In the array substrate shown in FIG. 8, the quantity of through holes 90 is two, and the two through holes 90 respectively correspond to both end portions of the conductive strip 50, and the conductive strip 50 is connected to the common electrode via the two through holes 90.

When the control circuit of the large-screen liquid crystal panel inputs an electric signal to the common electrode 80, the common electrode 80 can transmit the electric signal by means of the conductive strip 50. Since the conductive strip 50 is made of a metal material, its resistivity is much smaller than that of ITO, the difference in the electric signals in each region of the common electrode 80 is greatly reduced with good uniformity.

In one embodiment, the conductive strips 50 may also not be in the same layer as the plurality of data lines 40, as shown in FIG. 11.

In the array substrate shown in FIG. 11, a second dielectric layer 110 is disposed on the data line 40. The conductive strip 50 is disposed on the second dielectric layer 110 and corresponds to the scanning line 20. A planarization layer 120 is disposed on the conductive strip 50 and a through hole 130 is disposed on the planarization layer 120. The common electrode 80 is disposed on the planarization layer 120. The common electrode 80 is electrically connected to the conductive strip 50 via the through hole 130.

In this embodiment, the length of the conductive strip 50 may be less than or equal to the distance between the data lines 40 on the left and right sides of the sub-pixel unit.

Since the conductive strip 50 is insulated from the data line 40 by disposing at different layers, the length of the conductive strip 50 may be the same as the length of the entirety of the scanning lines 20, i.e., a plurality of sub-pixel units in the same row share the same conductive strip 50. For example, if there are M rows of scanning lines 20 in the array substrate, the M rows of conductive strips 50 correspond to the M rows of scanning lines.

Additionally, in the array substrate shown in FIG. 11, each sub-pixel unit corresponds to two through holes 130. It is understood that when the same row of sub-pixel units share the same conductive strip 50, the quantity of through holes 130 corresponding to each sub-pixel unit may be one, or a through hole 130 is disposed between every two sub-pixel units, for electrically connecting the common electrode 80 with the conductive strip 50.

Of course, the quantity and arrangement of the through holes 130 are not limited to the above, and may be set in accordance with parameters such as the size of the actual array substrate, and are not particularly limited thereto.

The FFS mode array substrate provided by the present embodiment is provided with a conductive strip between the scanning line and the common electrode, and the conductive strip is electrically connected to the common electrode. When the common electrode is applied with an electric signal, the common electrode can transmit the electric signal via the conductive strip, then the voltage difference among each region of the common electrode is reduced to maintain the voltage uniformity among each region of the common electrode, so that the liquid crystal panel using the FFS mode array substrate has a better display effect.

Although the present invention has been disclosed as preferred embodiments, the foregoing preferred embodiments are not intended to limit the present invention. Those of ordinary skill in the art, without departing from the spirit and scope of the present invention, can make various kinds of modifications and variations to the present invention. Therefore, the scope of the claims of the present invention must be defined.

What is claimed is:

1. A Fringe Field Switching (FFS) mode array substrate, comprising a plurality of scanning lines, a plurality of data lines, and a common electrode, further comprising a plurality of conductive strips disposed between the scanning lines and the common electrode, the conductive strips and the data lines being disposed in different layers, the conductive strips being electrically connected to the common electrode, for transmitting electric signals of the common electrode.

2. The FFS mode array substrate according to claim 1, wherein the FFS mode array substrate further comprises a dielectric layer, which is disposed between the data lines and the conductive strips, for insulating the data lines and the conductive strips.

3. The FFS mode array substrate according to claim 2, wherein the FFS mode array substrate further comprises a planarization layer, which is disposed on the conductive strips, and the common electrode is disposed on the planarization layer, wherein the planarization layer comprises through holes, and the common electrode is electrically connected with the conductive strips via the through holes.

4. The FFS mode array substrate according to claim 1, wherein the conductive strips and the scanning lines are disposed correspondingly.

5. The FFS mode array substrate according to claim 4, wherein a length of the conductive strip and a length of the scanning line are the same.

6. The FFS mode array substrate according to claim 5, wherein a quantity of the conductive strips and a quantity of the scanning lines are the same.

7. The FFS mode array substrate according to claim 1, wherein materials of the conductive strips comprise aluminum, copper or molybdenum.

8. A Fringe Field Switching (FFS) mode array substrate, comprising a plurality of scanning lines, a plurality of data lines, and a common electrode, further comprising a plurality of conductive strips disposed between the scanning lines and the common electrode, the conductive strips being electrically connected to the common electrode, for transmitting electric signals of the common electrode.

9. The FFS mode array substrate according to claim 8, wherein the conductive strips and the data lines are disposed apart from each other in the same layer.

10. The FFS mode array substrate according to claim 9, wherein the FFS mode array substrate further comprises a dielectric layer and a planarization layer, which are disposed on the data lines and the conductive strips, the common electrode is disposed on the planarization layer, wherein through holes are disposed in the dielectric layer and the planarization layer, the common electrode is electrically connected with the conductive strips via the through holes.

11. The FFS mode array substrate according to claim 10, wherein the through holes comprise two through holes corresponding with two end portions of the conductive strips, the common electrode is electrically connected with the conductive strips via the two through holes.

12. The FFS mode array substrate according to claim 8, wherein the conductive strips and the scanning lines are disposed correspondingly.

13. The FFS mode array substrate according to claim 8, wherein materials of the conductive strips comprise aluminum, copper or molybdenum.

14. The FFS mode array substrate according to claim 11, wherein shapes of the conductive strips comprise rectangular or a middle is rectangular and two end portions are semi-circular.

15. The FFS mode array substrate according to claim 9, wherein materials of the conductive strips are the same with the materials of the data lines, and the conductive strips are formed at the same time when the data lines are formed.

16. A manufacturing method of Fringe Field Switching (FFS) mode array substrate, comprising:
manufacturing a first metal layer on a substrate, to form a plurality of scanning lines;
manufacturing an insulating layer on the first metal layer; and
manufacturing a second metal layer, a third metal layer and a common electrode layer on the insulating layer, to individually form a plurality of data lines, a plurality of conductive strips and a common electrode;
wherein the conductive strips are disposed between the scanning lines and the common electrode, and the conductive strips are electrically connected to the common electrode.

17. The manufacturing method according to claim 16, wherein the second metal layer and the third metal layer are in the same layer, the step of manufacturing a second metal layer, a third metal layer and a common electrode layer on the insulating layer, to individually form a plurality of data lines, a plurality of conductive strips and a common electrode comprises:
manufacturing the second metal layer and the third metal layer on the insulating layer, to form the plurality of data lines and the plurality of conductive strips, wherein the data lines and the conductive strips are insulated and disposed apart from each other;
manufacturing in order a first dielectric layer and a first planarization layer on the second metal layer and the third metal layer; and
manufacturing the common electrode layer on the first planarization layer to form the common electrode.

18. The manufacturing method according to claim 17, wherein the step of manufacturing in order a first dielectric layer and a first planarization layer on the second metal layer and the third metal layer comprises:
manufacturing the first dielectric layer on the second metal layer and the third metal layer, to form a first sub through hole in the first dielectric layer by a first photomask; and
manufacturing the first planarization layer on the first dielectric layer, and forming a second sub through hole in the first dielectric layer by a second photomask, wherein a first through hole is formed by the first sub through hole and the second sub through hole together, the common electrode is electrically connected with the conductive strips via the first through hole.

19. The manufacturing method according to claim 16, wherein the second metal layer and the third metal layer are different layers, the step of manufacturing a second metal layer, a third metal layer and a common electrode layer on the insulating layer, to individually form a plurality of data lines, a plurality of conductive strips and a common electrode comprises:
manufacturing the second metal layer on the insulating layer, to form the plurality of data lines;
manufacturing a second dielectric layer on the second metal layer;
manufacturing the third metal layer on the second dielectric layer, to form the plurality of conductive strips;
manufacturing a second planarization layer on the third metal layer, to form a second through hole in the second planarization layer by a third photomask; and
manufacturing the common electrode layer on the second planarization layer to form the common electrode, wherein the common electrode is electrically connected with the conductive strips via the second through hole.

20. The manufacturing method according to claim 19, wherein the step of manufacturing the third metal layer on the second dielectric layer, to form the plurality of conductive strips comprises:
manufacturing the third metal layer on a position where the conductive strips and the scanning lines are disposed correspondingly, to form the plurality of conductive strips.
